(19) United States
(12) Patent Application Publication
(10) Pub. No.: US 2008/0227529 A1
(43) Pub. Date: Sep. 18, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/582,356

(22) Filed: Oct. 18, 2006

Related U.S. Application Data
(60) Provisional application No. 60/831,442, filed on Jul. 18, 2006.

(51) Int. Cl. G06F 17/00

(52) U.S. Cl. 463/21

(57) ABSTRACT

A stop control game which stops the symbols being scrolled by pressing a stop switch when a combination of the symbol “LOBSTER”s has come to a stop is executed in a unit game while the base game is being executed. When the player presses a stop switch to stop the symbols, a first payout table is selected if a combination of the symbol “CRAB”s has not come to a stop on the payline L, whereas a second payout table defining a larger amount of payout than the first payout table is selected if the combination of the symbol “CRAB”s has come to a stop on the payline. Then, if a winning combination is rearranged in the following game, payout occurs based on the selected payout table.

### CROSS-REFERENCE TO RELATED APPLICATION

This application is based upon and claims the benefit of U.S. Provisional Patent Application Ser. No. 60/831,442, filed on Jul. 18, 2006; the entire contents of which are incorporated herein by reference for all purposes.

### BACKGROUND OF THE INVENTION

1. Field of the Invention

The present invention relates to a slot machine for playing a game using game media such as coins or bills, and a playing method thereof.

2. Description of Related Art

With conventional slot machines, such as those disclosed in U.S. Pat. No. 6,960,133B1 or U.S. Pat. No. 6,012,983, a plurality of symbols starts to be scrolled on a display unit provided in front of a cabinet when the player inserts game media such as tokens, coins or bills into the insertion slot of the slot machine and presses the spin button. Subsequently, respective symbols automatically come to a stop. At this time, a random number is generated at the start of scrolling respective symbols, which is triggered by pressing the spin button. If it is arbitrarily determined by the random number to payout coins or credits associated with prizes such as a mystery bonus, or to transit to a bonus game such as the second game, transition from the base game to the bonus game occurs and the bonus game is executed.

Here, the slot machine is configured to payout a predetermined award when a winning combination occurs during execution of the game.

With such a conventional slot machine, the symbols being scrolled merely stop automatically, which has raised a desire for a slot machine having a new entertainment performance to appear.

### SUMMARY OF THE INVENTION

With the slot machine according to a first aspect of the present invention, there are a case in which a plurality of symbols that have been arranged on a display are automatically rearranged and a case in which the symbols are rearranged by accepting a control input signal from an external. The slot machine comprises a controller. When having rearranged the symbols by accepting the control input signal, the controller executes a control to vary an amount of payout for subsequent winning combinations depending on whether or not a specific combination of the symbols has been rearranged.

The slot machine of the first aspect of the present invention rearranges the symbols which have been arranged on a display by accepting the control input signal from an external. At this time, the controller executes a control to vary the amount of payout for winning combinations in subsequent games depending on whether or not a specific combination of the symbols has been rearranged.

With the slot machine according to a second aspect of the present invention, for rearranging a plurality of symbols arranged on a display, there are a case in which the plurality of symbols are automatically rearranged and a case in which the plurality of symbols are rearranged by accepting a control input from an external. The slot machine comprises a controller. The controller executes a unit game which rearranges the symbols by accepting the control input signal from an external, if a predetermined combination of the symbols has been rearranged as a result of automatically rearranging the plurality of symbols. In this unit game, the controller executes a control to vary the amount of payout for subsequent winning combinations depending on whether or not a specific combination of the symbols has been rearranged.

With the slot machine of the second aspect of the present invention, a unit game is executed which rearranges the symbols that have been arranged on a display by accepting a control input signal from an external, if a predetermined combination of the symbols is rearranged as a result of automatically rearranging the symbols which have been arranged on the display. Thus, in this unit game, the amount of payout is varied depending on whether or not a specific combination of the symbols has been rearranged.

The slot machine according to a third aspect of the present invention comprises a display for arranging a symbol matrix formed by a plurality of columns and a plurality of rows, and an arrangement controller. The arrangement controller selects and determines symbols to be arranged into the symbol matrix from a plurality of types of symbols in order to rearrange a plurality of symbols which have been arranged on the display as a new symbol matrix after scrolling the plurality of symbols, and executes an arrangement control to stop the scrolling state at the arrangement of the determined symbols. The slot machine further comprises a stop switch operable by a player and connected to the arrangement controller, a plurality of payout tables for setting different payouts respectively for the same winning combination, a stop switch controller, and a table selection controller. The stop switch controller, when a predetermined combination of the symbols has been rearranged along a payline set for the symbol matrix, executes a stop control game which sets the symbols to be capable of rearrangement regardless of the arrangement control of the arrangement controller, in accordance with the input timing by the player of the stop switch in the following unit game. The table selection controller, when a winning combination is rearranged in a subsequently executed unit game, selects different payout tables to determine the amount of payout depending on whether or not a specific combination of the symbols has been rearranged by execution of the stop control game.

With the slot machine of the third aspect of the present invention, different payout tables are selected when the stop control game is executed depending on whether or not a specific combination of the symbols has been rearranged. This determines the amount of payout when a winning combination is rearranged in subsequently executed unit games.

The playing method of the slot machine according to the fourth aspect of the present invention repeats execution of a unit game for rearranging a plurality of symbols into a combination of the symbols determined by the controller, from a state in which the plurality of symbols have been arranged on the display. In each of the unit games, there are a case in which a plurality of symbols that have been arranged on the display are automatically rearranged and a case in which the symbols are rearranged by accepting a control input signal from an external. When the symbols are rearranged by accepting a control input signal, a control is executed to vary the amount of payout for subsequent winning combinations depending on whether or not a specific combination of the symbols has been rearranged at the rearrangement by accepting the control input signal.

With the playing method of the slot machine of the fourth aspect of the present invention, the symbols which have been arranged on the display are rearranged by accepting a control input signal from an external in each unit game. At this time, the amount of payout for subsequent winning combinations is varied depending on whether or not a specific combination of the symbols has been rearranged.

The playing method executed by the slot machine according to the fifth aspect of the present invention includes the following steps. Namely, a step in which a plurality of symbols have been arranged on a display to be later rearranged thereon, the controller determines a plurality of symbols to be rearranged prior to their rearrangement to rearrange a combination of the symbols on the display; a step in which a stop switch connected to the controller is activating when the plurality of rearranged symbols compose a predetermined combination, and the plurality of symbols are set to be capable of rearrangement by input from the stop switch, regardless of the control of the controller, and a step in which the amount of payout to a player is varied depending on whether or not a specific combination of symbols has been rearranged by the input from the stop switch.

With the playing method executed by the slot machine of the fifth aspect of the present invention, as a result of rearranging the symbols which have been arranged on the display, the stop switch is activated if a predetermined combination of symbols is achieved, allowing the symbol which have been arranged on the display to be rearranged by operating the stop switch. Then, the operation of the stop switch varies the amount of payout to the player depending on whether or not a specific combination of symbols has been achieved.

The playing method executed by the slot machine according to the sixth aspect of the present invention repeats execution of unit games in which the controller executes a control to start a game by scrolling a plurality of symbols on the display and ends the game by stopping the scroll at a combination of symbols determined by the controller. The playing method includes the following steps. Namely, a first step in which, if a predetermined combination of symbols has been rearranged on the display, the symbols being scrolled on the display are put under a controlled state, so that they can be rearranged based on an input signal from the stop switch connected to the controller; a second step in which, under the controlled state, it is determined whether or not the combination of symbols rearranged based on the input signal turns out to be a specific combination; a third step in which it is determined whether or not a winning combination has been rearranged in a unit game after the controlled state; and a fourth step in which, if it is determined in the third step that a winning combination has been rearranged, the amount of payout to the player is made larger when it is affirmed that the determination result in the second phase indicates a specific combination, than when it is negated.

With the playing method executed by the slot machine of the sixth aspect of the present invention, a stop control game is executed in which a unit game is executed and, if a predetermined combination of symbols is rearranged as a result of rearranging the symbols which have been arranged on the display, the symbols are rearranged by accepting the input from the stop switch. Then, execution of the stop control game generates a larger amount of payout when a specific combination of symbols has been rearranged than when not having been rearranged.

### BRIEF DESCRIPTION OF THE DRAWINGS

FIG. 1 is a flow chart illustrating the playing method of the slot machine according to one embodiment of the present invention.

FIG. 2 is a perspective view illustrating the appearance of the slot machine according to one embodiment of the present invention.

FIG. 3 is a list of symbols and code numbers of respective symbols to be displayed in the five columns of the display areas of the slot machine according to one embodiment of the present invention.

FIG. 4A is a first payout table indicating the relation between winning combinations and amount of payout thereof.

FIG. 4B is a second payout table indicating the relation between winning combinations and amount of payout thereof.

FIG. 5 is a block diagram illustrating the control circuit of the slot machine according to one embodiment of the present invention.

FIG. 6 is a flow chart illustrating the procedure of the authentication reading processing of the gaming program and the gaming system program executed by the motherboard and the gaming board of the slot machine according to one embodiment of the present invention.

FIG. 7 is a flow chart illustrating the procedure of the base game executed by the slot machine according to one embodiment of the present invention.

FIG. 8 is a flow chart illustrating the procedure of the stop control game executed by the slot machine according to one embodiment of the present invention.

FIG. 9 is a flow chart illustrating the procedure according to a modification of the stop control game executed by the slot machine according to one embodiment of the present invention.

FIG. 10 is a flow chart illustrating the procedure of the determination process of the symbols to be stopped, which is executed by the slot machine according to one embodiment of the present invention.

FIG. 11 is a flow chart illustrating the procedure of the scroll process of symbols executed by the slot machine according to one embodiment of the present invention.

FIG. 12 is a flow chart illustrating process sequence of the bonus game executed by the slot machine according to one embodiment of the present invention.

FIG. 13 is an illustration of an exemplary display for notifying that the stop control game is being executed on the slot machine according to one embodiment of the present invention.

FIG. 14A is an illustration of an exemplary display when the stop control game is being executed on the payline L.

FIG. 14B is an illustration of an occasion when specific symbols have come to a stop in the stop control game.

FIG. 14C is an illustration of an occasion when specific symbols have not come to a stop in the stop control game.

### DETAILED DESCRIPTION OF THE INVENTION

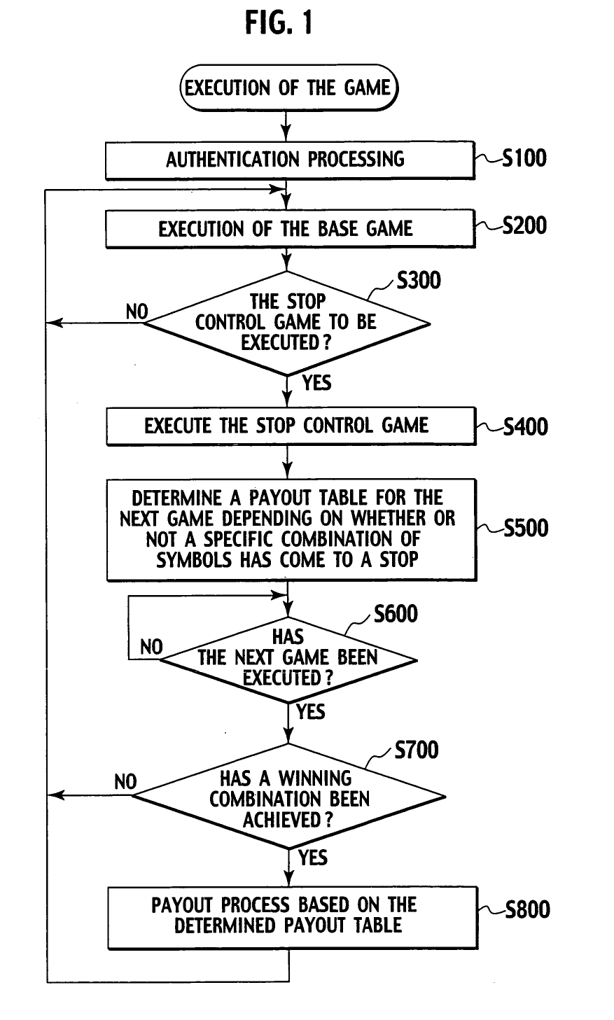

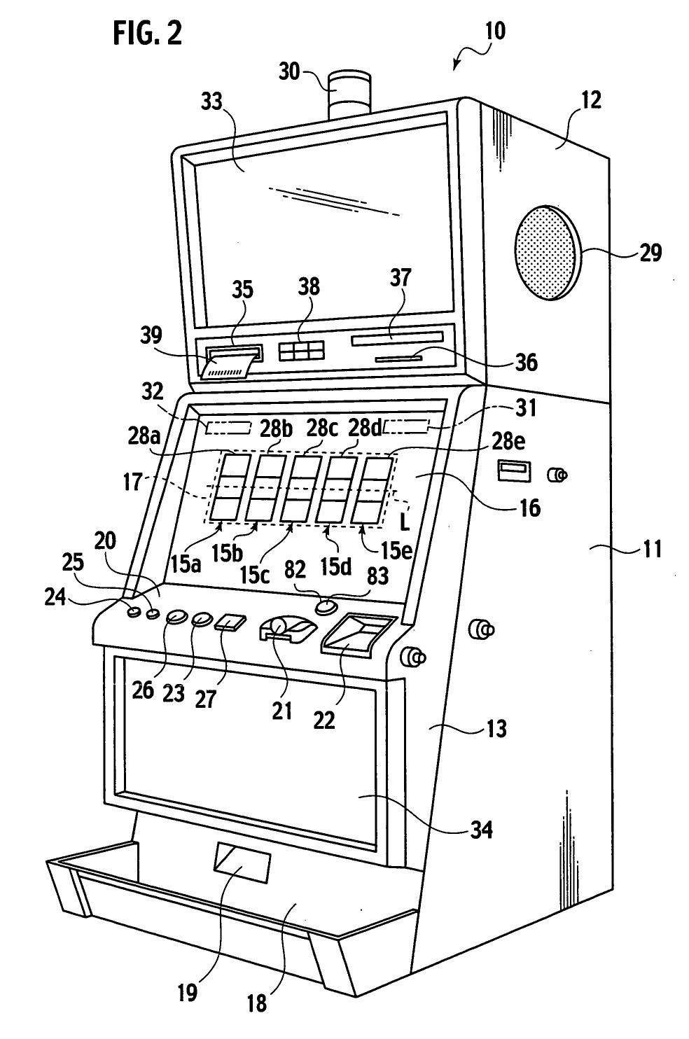

FIG. 1 is a flow chart illustrating the overview of the playing method of the slot machine according to the present invention. The general operation of the slot machine and the playing method according to the present invention will be described below, referring to the flow chart shown in FIG. 1 and the perspective view shown in FIG. 2.

When the slot machine according to the present invention is powered on and starts up, an authentication processing is executed first (step S100). In this authentication processing, an initial checking processing is executed, prior to starting the unit game, in order to check whether or not the program for operating the system is normally activated, whether or not there is any falsification of program, etc.

Next, the base game is executed (step S200). In the base game, when the spin button 23 is pressed with a desired number of credits have been bet, such as by inserting a coin into the coin insertion slot 21, the symbols start to scroll on each of the display areas 28 (28a to 28e) of the liquid crystal display unit 17 inside a 5-column×3-row matrix of display windows 15 (15a to 15e) provided on the front side of the cabinet 11. Subsequently, a unit game is executed in which scrolling is stopped to bring (rearrange) the symbols to a stop on each of the display areas 28.

In each unit game, a process for determining the symbols to be stopped on each of the display areas 28 (28a to 28e) is executed. If a combination of the symbols which may invoke the bonus trigger, for example, symbol “APPLE”s have come to a stop on the payline L provided on the middle portion across each of the display areas 28, the process proceeds to a bonus game.

In addition, if a predetermined condition, such that a combination of predetermined symbols (e.g., symbol “LOBSTER”s) has come to a stop across the display areas 28, is satisfied, a stop control game is executed in which the symbols being scrolled are stopped at the timing when the stop switch 82 is pressed by the player (steps S300 and S400).

When the stop control game is started, scrolling of the symbols on the display areas 28 (28a to 28e) is started again, activating the stop switch 82. Subsequently, the symbols being scrolled are stopped when the player presses the stop switch 82. Then a desired payout table is selected among a plurality of prepared payout tables according to whether or not specific symbols, for example symbol “CRAB”s, have come to a stop on the payline L provided in the middle portion of the five columns of the display areas 28 (28a to 28e) (step S500).

For example, a first payout table defining the amount of payout and a second payout table defining an amount of payout which is larger than the amount of the first payout table are provided for the winning combination associated with the payout. If specific symbols have come to a stop by execution of the stop control game, the second payout table is selected, whereas the first payout table is selected if specific symbols do not come to a stop.

Subsequently, scrolling of the symbols on the display areas 28 (28a to 28e) is started again (step S600). As a result, it is determined whether or not the combination of symbols which have come to a stop on the payline L provided on the display areas 28 (28a to 28e) of the liquid crystal display unit 17 is a winning combination associated with payout (step S700). An example of a winning combination includes the case in which the symbol “CHERRY”s have come to a stop on the payline L.

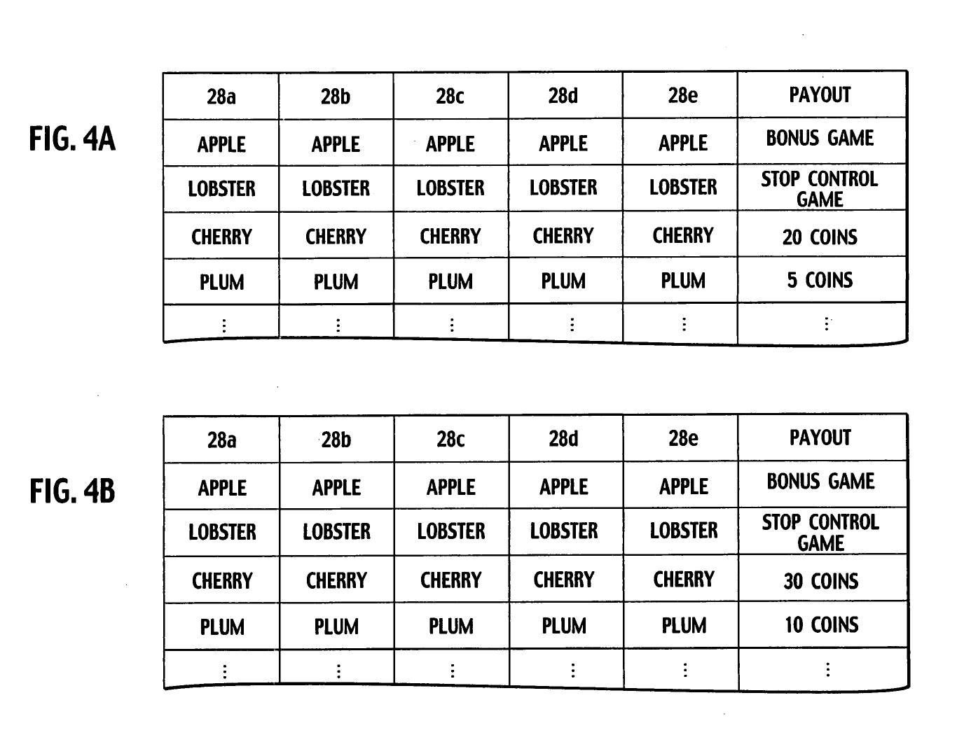

Then, payout is made based on the payout table determined in step S500 when a winning combination associated with payout has come to a stop on the payline L (step S800). For example, if the winning combination of “CHERRY”s has come to a stop on the payline L, the amount of payout is 30 coins in the second payout table (see FIG. 4B) whereas the amount of payout is 20 coins in the first payout table (see FIG. 4A).

In other words, when the player presses the stop switch 82 and succeeds in stopping the specific symbol “CRAB”s etc. in the stop control game executed by the process of step S400, the amount of payout is increased when symbols to be a winning combination have come to a stop in the following game, providing the player with a larger amount of payout.

Also in the above description, an example is given wherein the symbols are stopped and displayed on the display areas 28 (28a to 28e) corresponding to the 5-column×3-row matrix of display windows 15 (15a to 15e). However, the present invention is not limited to a 5-column×3-row matrix of display areas 28. Furthermore, an example of displaying the symbols on each of the display areas 28 using a liquid crystal display unit 17 is described. However, an arrangement using cylindrical-shaped, mechanical spinning reels having a plurality of symbols displayed on their side may be employed. In this case, the reels spin and subsequently stop so that the symbols come to a stop inside each of the display windows 15 (15a to 15e).

In the above example, a case is described in which two payout tables, i.e., the first payout table and the second payout table are provided. However, three or more payout tables may be provided to execute the stop control game multiple times and select the payout table according to the number of times specific symbols come to a stop.

Furthermore, the above example describes a base game in which the symbols are scrolled vertically relative to each of the display areas 28 (28a to 28e) and subsequently stopped (rearranged). However, the symbols may be switched over on each of the display areas 28 (28a to 28e), and displayed (rearranged).

Next, an arrangement of the slot machine 10 according to one embodiment of the present invention will be explained, referring to the perspective view shown in FIG. 2. The slot machine 10 is installed in a gaming facility.

With the slot machine 10, a coin, a bill, or electronic value information corresponding to these is used as game media for executing a unit game. However, in the present invention, the game media is not limited to those mentioned above and may include a medal, a token, an electronic money, a ticket, or the like, for example. In addition, the above-mentioned ticket may include but not limited to a bar-coded ticket described below, for example.

As shown in FIG. 2, the slot machine 10 comprises a cabinet 11, a top box 12 provided on the top of the cabinet 11, and a main door 13 provided on the front side of the cabinet 11.

Inside the cabinet 11, a liquid crystal display unit 17 is provided for scrolling a 5-column×3-row matrix of symbols inside display windows 15 (15a to 15e). The liquid crystal display unit 17 comprises display areas 28 (28a to 28e) for displaying the 5-column×3-row matrix of symbols. In other words, when the base game is executed, the symbols are scrolled in the 5-column×3-row matrix of display areas 28 (28a to 28e), allowing the player to view the symbols being scrolled through the display windows 15 (15a to 15e).

Here, in the present embodiment, a 5-column×3-row matrix of display areas 28 (28a to 28e) of the liquid crystal display unit 17 is described as an exemplary display. However, the symbols may be displayed through the display windows 15 by spinning and subsequently stopping mechanical reels with the symbols displayed on their side. Also, the matrix of display areas 28 is not limited to five columns and three rows.

In addition, a stop switch 82 is provided, in the lower part of the liquid crystal display unit 17 inside the cabinet 11, for stopping the symbols being scrolled when the stop control game is started. If the stop switch 82 is pressed by the player, the symbols come to a stop at the timing when the stop switch 82 is pressed.

Additionally, when the stop control game is started, a display lamp 83 provided in the stop switch 82 lights up, notifying the player that the symbols being scrolled on the display areas 28 can be stopped by pressing the stop switch 82.

In front of the liquid crystal display unit 17 in the main door 13 is provided a lower display panel 16. The lower display panel 16 has a transmissive liquid crystal panel to display, during the game, various information or staging images relating to the game.

A credit number display section 31 and a payout number display section 32 are provided in the lower display panel 16. The number of coins having been credited is displayed as images on the credit number display section 31. The number of coins to be paid out is displayed as images on the payout number display section 32, if the combination of the symbols which have come to a stop on the payline L described below turns out to be a winning combination.

On the lower display panel 16 are provided five columns of display windows 15 (15a to 15e), which allow to view the symbols displayed on the five columns of the display areas 28 (28a to 28e) of the liquid crystal display unit 17 provided inside the lower display panel 16. In addition, a single payline L running horizontally across the display windows 15 (15a to 15e) is formed along the middle portion of the display windows 15 (15a to 15e). The payline L defines a combination of the symbols. If a combination of the symbols which have come to a stop on the payline L turns out to be a winning combination, a number of coins according to the winning combination and the number of coins inserted (number of bets) are paid out.

Here, in the present embodiment, an example is described in which a single payline L is provided. However, three paylines horizontally crossing the top, the middle and the bottom rows of the five columns of the display windows 15 (15a to 15e), or a payline running diagonally (V-shaped or inverted V-shaped), for example, may be formed. In this case, one or more paylines are activated according to the number of the coins inserted, and when a winning combination is achieved on the payline, one or more coins are paid out according to the combination.

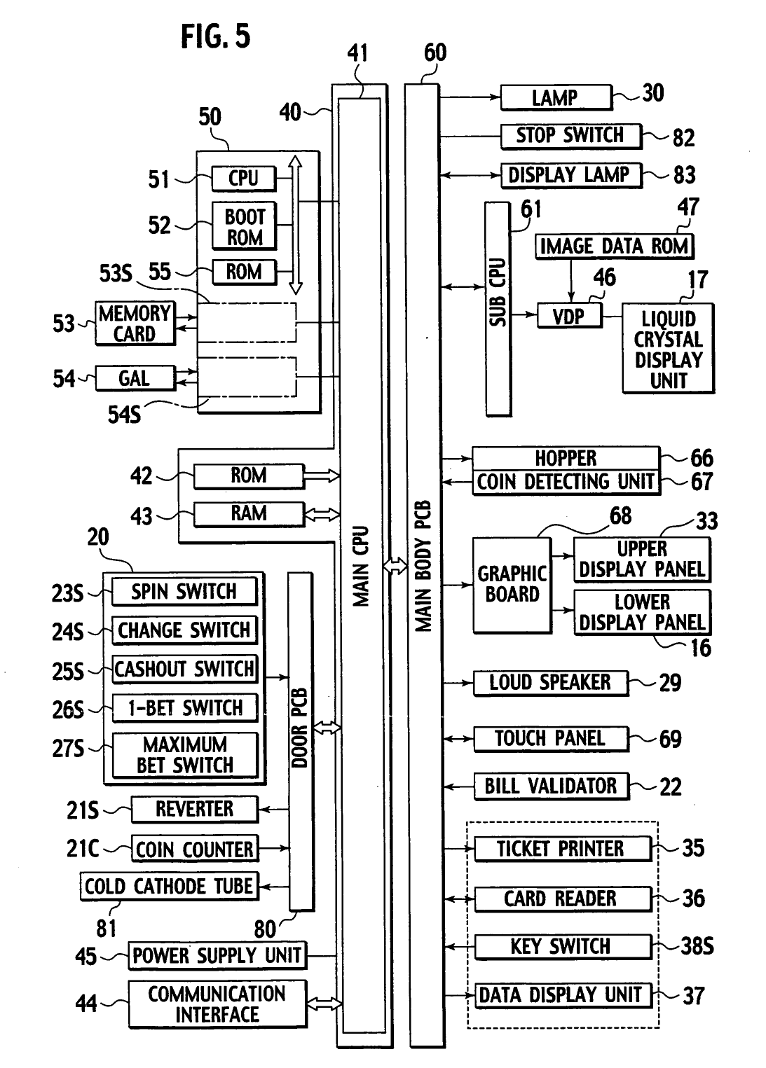

Furthermore, a touch panel 69 (see FIG. 5) is provided on the front side of the lower display panel 16, allowing the player to operate the touch panel 69 to input various commands.

At the bottom of the lower display panel 16 are provided a control panel 20 having a plurality of buttons 23 to 27 into which commands with regard to the progress of the game are entered by the player, a stop switch 82, a coin insertion slot 21 for accepting coins into the cabinet 11, and a bill validator 22.

Additionally, in the present embodiment, an example is described in which symbols being scrolled are stopped using a stop switch 82. However, by providing a transmissive touch panel on the front side of the display windows 15 in place of the mechanical stop switch 82, the touch panel may be used in place of the stop switch 82. As such a touch panel, a touch panel employed in mobile terminals or ATMs of banks may be used. As thus described, the player can provide instructions for rearrangement by touching the symbols he or she wants to stop (rearrange) while viewing the changing states of the symbols on the display areas 28 through the window 15 by providing a touch panel as the stop switch 82 on the front side of the display windows 15. Such a rearrangement operation is advantageous in that the operation can be performed with a feel that the player is directly touching the symbol.

The control panel 20 has a spin button 23, a change button 24, a cash out button 25, a 1-bet button 26, and a maximum bet button 27 provided therein. The spin button 23 is a button for inputting the start of scrolling command of the symbols displayed on the display areas 28. The change button 24 is a button used when requesting money exchange to the crew of a gaming facility. The cash out button 25 is a button for entering commands to payout the credited coins into the tray 18.

The 1-bet button 26 is a button for inputting a command to bet a single coin on the game from the coins which have been credited. The maximum bet button 27 is a button for inputting a command to bet on the game a maximum number (e.g., 50) of coins allowed to be bet on a single game from those which have been credited.

The stop switch 82 is a switch, which is activated when the stop control game is started, for allowing the player to perform an operation to stop the symbols being scrolled. In addition, a display lamp 83 is provided in the stop switch 82. The display lamp 83 lights up when the operation of the stop switch 82 is activated and notifies the player that the operation of the stop switch 82 is activated, as discussed below. Note that, an operation lever, a track ball, a touch panel, or the like may be used in place of the stop switch 82.

The bill validator 22 identifies whether or not the bill is authentic and accepts legitimate bills into the cabinet 11. Here, the bill validator 22 may be configured to be able to read a bar-coded ticket 39 described below. A berry glass 34 having characters of the slot machine 10 drawn thereon is provided on the lower front side of the main door 13, i.e. at the bottom of control panel 20.

On the front side of top box 12 is provided an upper display panel 33. The upper display panel 33 comprises a liquid crystal panel to display staging images, introduction of game contents, and rules of the games, for example.

In addition, a loudspeaker 29 for audio output is provided on the top box 12. At the bottom of the upper display panel 33 are provided a ticket printer 35, a card reader 36, a data display unit 37, and a key pad 38. The ticket printer 35 prints bar codes on the ticket, which are coded data such as the number of credits, date/time, and the identification number of the slot machine 10 and outputs the ticket as the bar-coded ticket 39. The player can play games on other slot machines using the bar-coded ticket 39, or exchange the bar-coded ticket 39 with bills at the cashier of the gaming facility.

The card reader 36 reads and writes data from and to a smart card. The smart card is a card carried by the player, and stores data used for identifying the players or data relating to the gaming history played by the player.

The data display unit 37 comprises a fluorescent display or the like, and displays data read by the card reader 36 or data entered by the player using the key pad 38, for example. The key pad 38 inputs commands or data with regard to ticket publication.

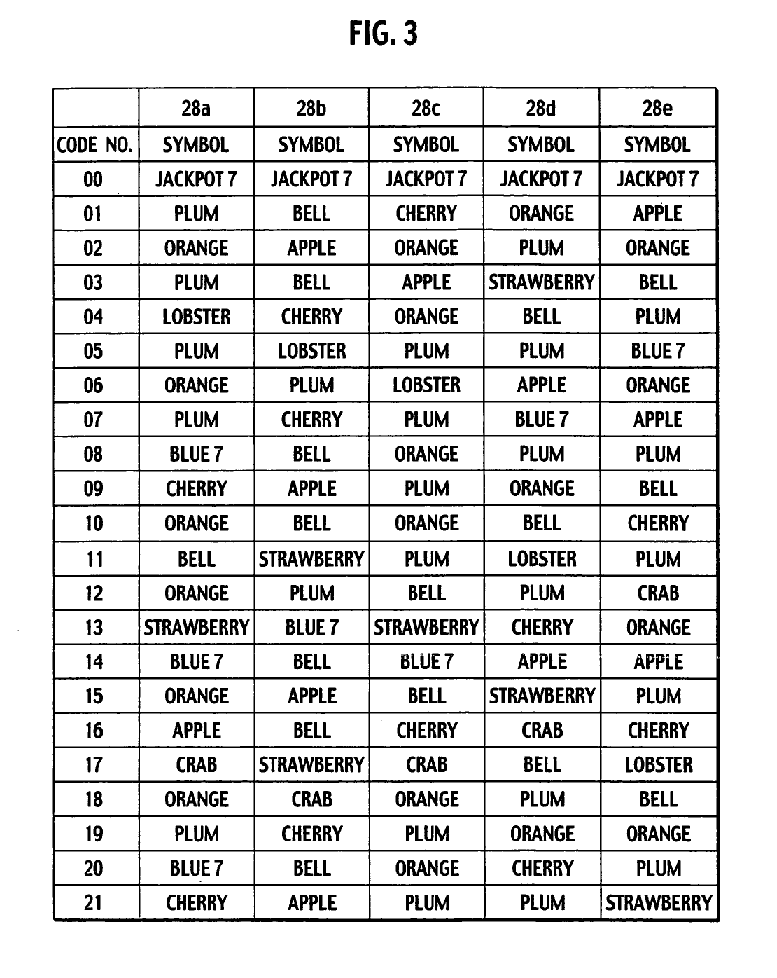

FIG. 3 is an explanatory list of columns of symbols to be scrolled on each of the display areas 28 (28a to 28e) provided on the liquid crystal display unit 17 installed in the cabinet 11. As shown in FIG. 3, columns of a total of 22 symbols composed of code number “00” to “21”, respectively, are scrolled on each of the display areas 28 (28a to 28e). The columns of symbols are different for each of the display areas 28 (28a to 28e).

The symbols to be displayed on each of the display areas 28 (28a to 28e) are composed by combining the symbols “JACKPOT 7”, “BLUE 7”, “BELL”, “CHERRY”, “STRAWBERRY”, “PLUM”, “ORANGE”, “APPLE”, “LOBSTER”, and “CRAB”. In addition, a winning combination associated with payout is set by combination of the above symbols. Additionally, a first payout table and a second payout table are set as tables for determining the amount of payout when a winning combination is achieved.

FIG. 4A shows the first payout table. The first payout table is selected when the normal base game is being executed or when a combination of the specific symbols (e.g., symbol “CRAB”s) has not come to a stop in the stop control game. As shown in FIG. 4A, a bonus trigger is invoked when the symbol “APPLE”s have come to a stop on the payline L of the five columns of the display areas 28 (28a to 28e), shifting the game state from the base game to the bonus game.

In addition, the stop control game is executed if a combination of predetermined symbols; “LOBSTER” has come to a stop on the payline L. If symbols; “CHERRY” have come to a stop on the payline L, payout of 20 coins is executed. If symbols; “PLUM” have come to a stop on the payline L, payout of five coins is executed.

On the other hand, FIG. 4B shows the second payout table. The second payout table is selected in the following game if a combination of specific symbols (e.g., symbols; “CRAB”) has come to a stop in the stop control game. If a combination of the symbols; “APPLE” has come to a stop on the payline L as shown in FIG. 4B, the bonus game trigger is invoked, shifting the game state from the base game to the bonus game.

If a combination of the symbols; “LOBSTER” has come to a stop on the payline L, the stop control game is executed. If a combination of the symbols; “CHERRY” has come to a stop on the payline L, 30 coins are paid out. If a combination of the symbols; “PLUM” has come to a stop on the payline L, 10 coins are paid out.

In other words, the second payout table is prepared to provide a larger amount of payout of coins than the first payout table when symbols composing a winning combination have come to a stop on the payline L. As discussed below, the first payout table is selected in the usual state to determine the amount of payout and executes the stop control game, in which if a combination of specific symbols such as the combination of “CRAB”s, for example, has come to a stop on the payline L, the second payout table is selected.

In addition, the bonus game, which is executed when a combination of the symbol “APPLE”s has come to a stop on the payline L, is a more advantageous game state than the base game. In the present embodiment, the bonus game is a free game (a game which can be played for a predetermined number of times without betting coins). In the present invention, the bonus political game is not particularly limiting as long as it provides the player with an advantageous game state. Additionally, the bonus game which is advantageous for the player is not particularly limiting as long as it is more advantageous than the base game. There may be a variety of more advantageous states such as a state in which more game media can be obtained than the base game, a state in which game media can be obtained with a higher probability than the base game, a state in which a smaller amount of game media is consumed than the base game, and so on. Specifically, bonus games may include a free game, a second game, or the like.

Scrolling of the symbols displayed (arranged) on each of the display areas 28 (28a to 28e) starts when the 1-bet button 26 or the maximum bet button 27 is pressed and, subsequently, the spin button 23 is pressed. After a predetermined time period has passed since the scrolling of respective symbols started, scrolling of respective symbols is stopped (rearranged). At this time, any symbol of the column of symbols on each of the display areas 28 (28a to 28e) shown in FIG. 3 come to a stop across the display areas 28 (28a to 28e) inside the display windows 15 (15a to 15e).

Furthermore, various winning combinations (see FIGS. 4A and 4B) are predetermined for respective symbols and a certain number of coins according to the winning combination are added to the credits possessed by the player when symbols composing a winning combination have come to a stop on the payline L. In addition, when a bonus game is triggered, that is, when a combination of five “APPLE” symbols has come to a stop on the payline L in the present embodiment, the game state shifts from the base game state to the bonus game state.

FIG. 5 is a block diagram illustrating a control circuit of the slot machine 10 shown in FIG. 2. As shown in FIG. 5, the control circuit comprises a motherboard 40, a main body PCB (Printed Circuit Board) 60, a gaming board 50, a sub CPU 61, a door PCB 80, and various types of components such as switches or sensors.

The gaming board 50 comprises a CPU (Central Processing Unit) 51, a ROM 55 and a boot ROM 52, which are connected to each other by an internal bus, a card slot 53S corresponding to a memory card 53, and an IC socket 54S corresponding to a GAL (Generic Array Logic) 54.

The Memory card 53 stores gaming programs and gaming system programs. The gaming programs include a stop symbol determination program. The stop symbol determination program is a program for determining the symbol (code number corresponding to the symbol) to be stopped on the payline L of each of the display areas 28 (28a to 28e). The stop symbol determination program includes symbol weighting data corresponding to each of a plurality of payout rates (e.g., 80%, 84%, and 88%). The symbol weighting data indicates the relation between the code numbers (see FIG. 3) of respective symbols and one or more random number values within a predetermined numerical range (0 to 255), respectively for the five columns of the display areas 28 (28a to 28e).

The payout rate is defined based on the payout rate setting data which is output from the GAL 54. Based on the symbol weighting data corresponding to the payout rate, the symbols to be stopped are determined.

In addition, the card slot 53S, configured to be capable of inserting therein and removing therefrom the memory card 53, is connected to the motherboard 40 by the IDE bus. Thus, the type or content of the game to be executed on the slot machine 10 can be changed by removing the memory card 53 from the card slot 53S, writing another gaming program and gaming system program in the memory card 53, and inserting the memory card 53 into the card slot 53S.

The gaming programs include a program relating to the progress of the game and a program for shifting the state to the bonus game. In addition, the gaming programs include image data and sound data to be output during the game. Furthermore, the gaming programs include image data and sound data as notification data for notifying the player, when the stop control game is started by the procedure described below, that the stop operation of the symbols being scrolled using the stop switch 82 is activated.

The GAL 54 comprises a plurality of input ports and output ports and, when data is entered in an input port, outputs data corresponding to the entered data from an output port. The data output from the output port is the payout rate setting data mentioned above.

In addition, IC socket 54S, configured to be capable of attaching thereto and removing therefrom the GAL 54, is connected to the motherboard 40 by the PCI bus. Thus, the payout rate setting data to be output from the GAL 54 can be changed by removing the GAL 54 from the IC socket 54S, rewriting the program to be stored in the GAL 54, and attaching the GAL 54 to the IC socket 54S.

The CPU 51, the ROM 55 and the boot ROM 52 connected to each other by an internal bus are connected to the motherboard 40 by PCI bus. The PCI bus transmits signals between the motherboard 40 and the gaming board 50, as well as supplying power from the motherboard 40 to the gaming board 50. The ROM 55 stores country identification information and an authentication program. The boot ROM 52 stores a preliminary authentication program and a program (boot code) by which the CPU 51 starts the preliminary authentication program.

The authentication program is a program for certifying the gaming program and the gaming system program (falsification check program). The authentication program is a program for checking and proving that the gaming program and the gaming system program have not been falsified with. In other words, the authentication program is written in accordance with the certifying procedure of the gaming program and the gaming system program. The preliminary authentication program is program for certifying the authentication program. The preliminary authentication program is written in accordance with the procedure of certifying the authentication program, that is, to prove that the authentication program supposed to execute the authentication processing has not been falsified with.

The motherboard 40 comprises a main CPU 41 (controller), a ROM (Read Only Memory) 42, a RAM (Random Access Memory) 43, and a communications interface 44.

The main CPU 41 has functionality as a controller for controlling the entire slot machine 10. Particularly, the main CPU 41 controls, when credits have been bet and the spin button 23 is pressed, outputting a command signal to cause the sub CPU 61 to scroll the symbols on each of the display areas 28 (28a-28e) of the liquid crystal display unit 17, determining the symbols to be stopped at a position on the middle portion (on the payline L) after the symbols on each of the display areas 28 (28a-28e) have been started scrolling, and displaying the symbols in such a manner that the determined symbols stop on the payline L.

In other words, the main CPU 41 has a functionality as an arrangement controller for controlling the arrangement in order to rearrange, after putting a plurality of symbols displayed on the display (liquid crystal display unit 17) in a scrolling state, the symbols into a new symbol matrix, in such a manner that the symbols to be arranged into a symbol matrix are selected and determined from a plurality of types of symbols and the determined symbols are stopped from the scrolling state.

In addition, the main CPU 41 has a functionality as a stop switch controller for executing the stop control game which activates the stop switch 82 in the following unit game if a combination of predetermined symbols (e.g., symbol “LOBSTER”s) has been rearranged on the payline L provided for the symbol matrix and allows rearrangement of the symbols being scrolled on the display areas 28 in accordance with the input timing of the stop switch 82 by the player, regardless of the arrangement control of the arrangement controller.

Furthermore, the main CPU 41 has a functionality as a payout table selection controller for selecting different payout tables and, as described below, determining the payout if a winning combination is rearranged on the display areas 28 (28a-28e) in the following game, depending on whether or not specific symbols have been rearranged by execution of the stop control game (e.g., when a combination of the symbol “CRAB”s has come to a stop on the payline L) or whether the specific symbols have not been rearranged.

The ROM 42 stores programs such as the BIOS (Basic Input/Output System) executed by the main CPU 41 and also stores data to be used permanently. When the BIOS is executed by the main CPU 41, an initialization process of each peripheral unit is executed and a read process for reading the gaming program and the gaming system program stored in the memory card 53 via the gaming board 50 is started.

The RAM 43 stores data and programs used when the main CPU 41 executes the processes.

The communications interface 44 is for providing communication between the host computer and the like provided in the gaming facility via a communication network.

In addition, a main body PCB (Printed Circuit Board) 60 and a door PCB 80, which will be described below, are connected to the motherboard 40 by a USB (Universal Serial Bus), respectively. Furthermore, a power unit 45 is connected to the motherboard 40. When electric power is supplied to the motherboard 40 from the power unit 45, the main CPU 41 of the motherboard 40 is activated, and electric power is also supplied to the gaming board 50 via a PCI bus, activating the CPU 51.

Devices and units which generate input signals to be fed to the main CPU 41, as well as devices and units whose operation is controlled by control signals output from the main CPU 41 are connected to the main body PCB 60 and the door PCB 80. The main CPU 41 executes arithmetic processes and stores their result in the RAM 43, or transmits control signals to respective devices and units as control processes for the respective devices and units, by executing the gaming programs and the gaming system program stored in the RAM 43, based on input signals fed to the main CPU 41.

To the main body PCB 60 are connected: a lamp 30, a sub CPU 61, a hopper 66, a coin detecting unit 67, a graphic board 68, a loudspeaker 29, a touch panel 69, a bill validator 22, a ticket printer 35, a card reader 36, a key switch 38S, and a data display unit 37. Furthermore, a stop switch 82 and a display lamp 83 provided corresponding to the stop switch 82 are connected to the main body PCB 60.

The turning on and off of the lamp 30 is controlled based on control signals output from the main CPU 41.

The sub CPU 61 controls the scrolling of the symbols on the five columns of the display areas 28 (28a-28e) provided on the liquid crystal display unit 17, and is connected to the VDP (Video Display Processor) 46.

The VDP 46 reads out the image data of symbols stored in the image data ROM 47, generates scroll images to be displayed on the liquid crystal display unit 17, and outputs the scroll images to the liquid crystal display unit 17.

The hopper 66 is provided inside the cabinet 11 and pays out a predetermined number of coins from the coin payout opening 19 to the coin tray 18 based on control signals output from the main CPU 41. The coin detecting unit 67 is provided inside the coin payout opening 19 and outputs the input signal to the main CPU 41 if it has detected that a predetermined number of coins have been paid out from the coin payout opening 19.

The graphic board 68 controls display of images in the upper display panel 33 and lower display panel 16 except the symbols to be displayed on the display areas 28, based on control signals output from the main CPU 41. The number of credits stored in the RAM 43 is displayed on the credit number display section 31 of the lower display panel 16. In addition, the number of coins paid out is displayed on the payout number display section 32 of the lower display panel 16. In addition, the graphic board 68 comprises a VDP for generating image data based on control signals output from the main CPU 41 and a video RAM for temporarily storing the image data generated by the VDP.

The bill validator 22 reads the images of the bills to accept legitimate bills into the cabinet 11. In addition, upon accepting a legitimate bill, the bill validator 22 outputs an input signal to the main CPU 41 according to the value of the bill. The main CPU 41 stores, in the RAM 43, a number of credits corresponding to the value of the bill, the value having been transmitted by the input signal.

The ticket printer 35 prints, based on control signals output from the main CPU 41, bar codes on the ticket expressing coded data such as number of credits stored in the RAM 43, time and date, identification number of the slot machine 10, or the like, and outputs the bar-coded ticket 39.

The card reader 36 reads data from the smart card and transmits the data to the main CPU 41, or writes data into the smart card based on control signals from the main CPU 41. The key switch 38S is provided on the key pad 38 and outputs, when the key pad 38 is operated by the player, the entered signal to the main CPU 41.

The data display unit 37 displays, based on control signals output from the main CPU 41, the data read by the card reader 36 or the data entered via the key pad 38 by the player.

The stop switch 82 is a button for stopping the symbols being scrolled when the stop control game described below is executed. When the stop control game is executed, the stop switch 82 is activated and the display lamp 83 lights up. When the stop switch 82 is pressed by the player, the sub CPU 61 controls the symbols being scrolled to be stopped at the timing of pressing the button.

A control panel 20, a revertor 21S, a coin counter 21C, and a cold cathode tube 81 are connected to the door PCB 80. On the control panel 20, a spin switch 23S corresponding to the spin button 23, a change switch 24S corresponding to the change button 24, a cash out switch 25S corresponding to the cash out button 25, a 1-bet switch 26S corresponding to the 1-bet button 26, and a maximum bet switch 27S corresponding to the maximum bet button 27 are provided. Respective switches 23S to 27S output, when their corresponding buttons 23 to 27 are operated by the player, the input signals to the main CPU 41.

The coin counter 21C is provided inside the coin insertion slot 21 and discriminates whether or not the coin inserted into the coin insertion slot 21 by the player is legitimate. Coins other than legitimate ones are ejected from the coin payout opening 19. In addition, upon detecting a legitimate coin, the coin counter 21C outputs the input signal to the main CPU 41.

The revertor 21S operates based on control signals output from the main CPU 41 to distribute the coins recognized as legitimate coins by the coin counter 21C to either the cashbox (not shown) or the hopper 66 provided inside the slot machine 10. In other words, when the hopper 66 is filled with coins, legitimate coins are distributed to the cashbox by the revertor 21S. On the other hand, when the hopper 66 is not filled with coins, legitimate coins will be distributed to the hopper 66.

The cold cathode tube 81 functions as a back light provided in the lower display panel 16 and the back side of the upper display panel 33, and lights up based on control signals output from the main CPU 41.

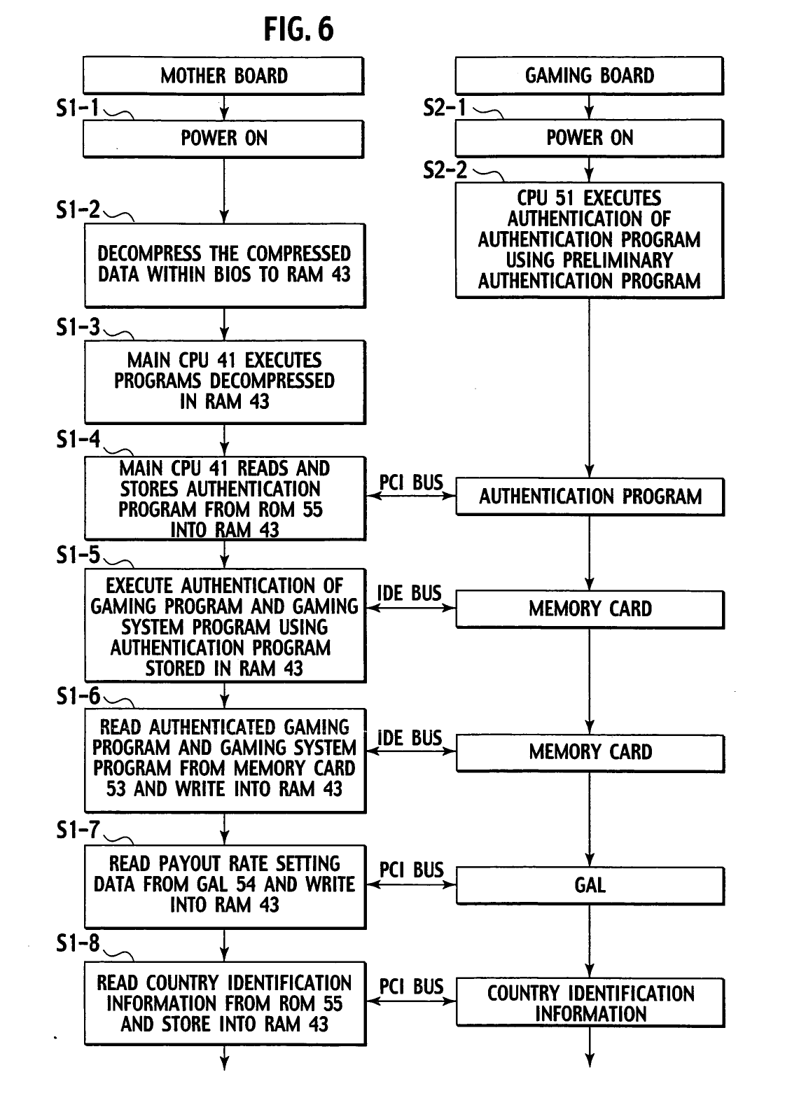

Next, a specific process executed in the slot machine 10 will be described. FIG. 6 is a flow chart illustrating the procedure (process of step S100 shown in FIG. 1) of the authentication reading processing of the gaming program and the gaming system program executed by the motherboard 40 and the gaming board 50 shown in FIG. 5. Here, it is assumed that a memory card 53 is attached to the card slot 53S on the gaming board 50, and GAL 54 is attached to the IC socket 54S.

First, upon switching on the power switch in the power unit 45, the motherboard 40 and the gaming board 50 are activated (steps S1-1 and S2-1). When the motherboard 40 and the gaming board 50 are activated, separate processes are executed in parallel. Specifically, in the gaming board 50, the CPU 51 reads out the preliminary authentication program stored in the boot ROM 52 and executes a preliminary authentication in accordance with the read-out preliminary authentication program to check and prove, before taking into the motherboard 40, that the authentication program has not been falsified with (step S2-2).

On the other hand, in the motherboard 40, the main CPU 41 executes the BIOS stored in the ROM 42 and decompresses the compressed data embedded in the BIOS to the RAM 43 (step S1-2). Then the main CPU 41 executes the BIOS which has been decompressed into the RAM 43 and executes diagnosis and initialization of various peripheral units (step S1-3).

Then, since the ROM 55 of the gaming board 50 is connected to the main CPU 41 via the PCI bus, the main CPU 41 reads out the authentication program stored in the ROM 55. Furthermore, the main CPU 41 executes a process to store the read-out authentication program in the RAM 43 (step S1-4).

Next, the main CPU 41 accesses the memory card 53 attached to the card slot 53S via the IDE bus. Then, the main CPU 41 reads out the gaming program and the gaming system program stored in the memory card 53.

Next, the main CPU 41 executes authentication to check and prove, in accordance with authentication program stored in the RAM 43, that the read-out gaming program and the gaming system program have not been falsified with (step S1-5).

If the authentication processing is completed normally, the main CPU 41 stores the certified gaming program and gaming system program into the RAM 43 (step S1-6). Next, the main CPU 41 accesses the GAL 54 connected to the IC socket 54S via the PCI bus, and reads the payout rate setting data from GAL 54 and stores it into the RAM 43 (step S1-7). Next, the main CPU 41 reads the country identification information stored in the ROM 55 of the gaming board 50 via the PCI bus, and stores the read-out country identification information in the RAM 43 (step S1-8).

After executing the above-mentioned process, the main CPU 41 advances the base game as described below, by sequentially reading out and executing the gaming program and the gaming system program.

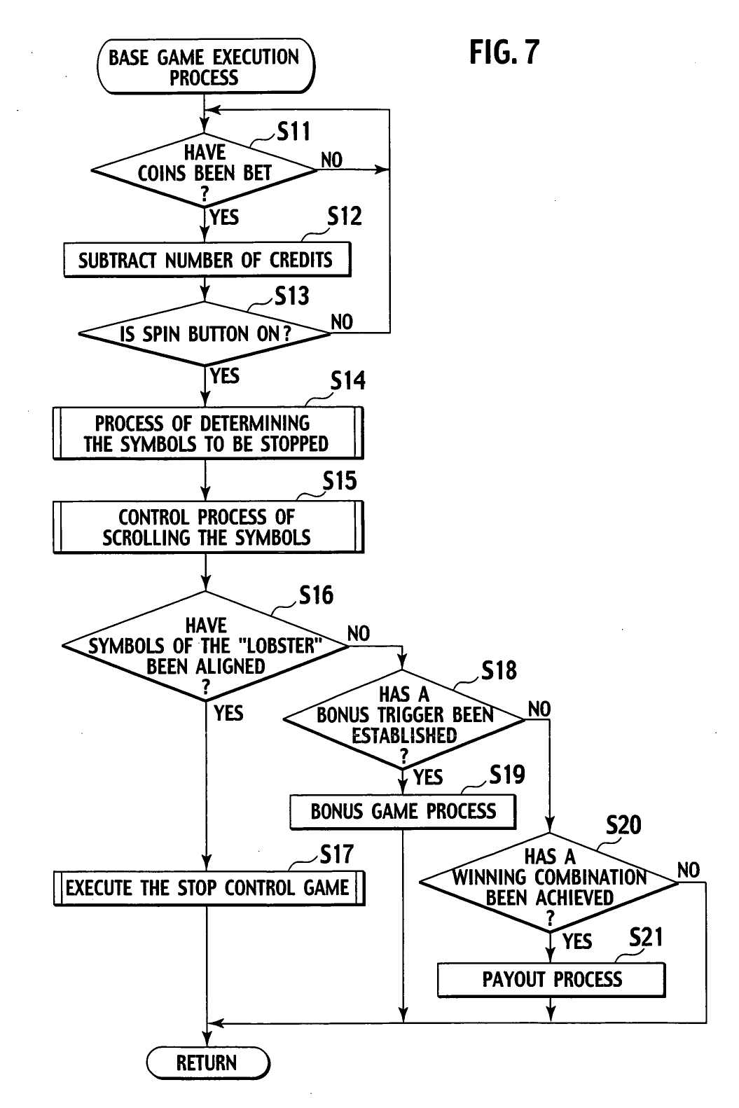

After the authentication reading processing shown in FIG. 6 has been executed, the main CPU 41 starts the execution process of the base game. FIG. 7 is a flow chart illustrating a specific process sequence of execution process of the base game shown in step S200 of FIG. 1.

In base game execution process, the main CPU 41 first determines whether or not a coin has been bet (step S11). In this process, the main CPU 41 determines whether or not an input signal which is output from the 1-bet switch 26S when the 1-bet button 26 is pressed, or an input signal which is output from the maximum bet switch 27S when the maximum bet button 27 is pressed is accepted. If it is determined that no coin has been bet, the process returns to step S11.

On the other hand, if it is determined in step S11 that coins have been bet, the main CPU 41 executes a process to subtract the number of credits stored in the RAM 43 according to the number of coins bet (step S12). Here, if the number of coins bet is larger than that of credits stored in the RAM 43, the process returns to step S11 without subtracting the number of credits stored in the RAM 43. In addition, if the number of coins bet exceeds an upper limit (50 in the present embodiment) which can be bet for a single game, the process proceeds to step S13 without subtracting the number of credits stored in the RAM 43. In this condition, the symbols can be displayed in a scrolling state on the display areas 28 (28a to 28e).

Next, the main CPU 41 determines whether or not the spin button 23 is turned on (step S13). In this process, when the spin button 23 is turned on the main CPU 41 determines whether or not an input signal which is output from the spin switch 23S is accepted.

If it is determined that the spin button 23 has not been turned on, the process returns to step S11. Here, the main CPU 41 cancels the subtraction result in step S12 if the spin button 23 is not turned on (for example, a command to finish the game has been input without turning on the spin button 23).

In the present embodiment, a case will be described in which a process of subtracting the number of credits (step S12) is executed after the coins have been bet (step S11) and before determining whether or not the spin button 23 has been turned on (step S13). However, the present invention is not limited to this. For example, whether or not the spin button 23 has been turned on may be determined (step S13) after the coins have been bet (step S11), then the process of subtracting the number of credits (step S12) may be executed if it is determined that the spin button 23 has been turned on (YES in step S13).

Then the main CPU 41 executes a process of determining the symbols to be stopped (step S14) if it is determined that spin button 23 has been turned on in step S13 of FIG. 7. In this process of determining the symbols to be stopped, the main CPU 41 determines, by executing a stop symbol determination program stored in the RAM 43, the symbols to be displayed through the display windows 15 when the symbols come to a stop on each of the display areas 28 (28a to 28e). This determines the combination of the symbols which will stop on the payline L.

Next, the main CPU 41 executes a process of scrolling the symbols (step S15). This is a process which stops, after scrolling of the symbols on each of the display areas 28 (28a to 28e) has been started, the symbols on each of the display areas 28 (28a to 28e) so that the symbols determined in step S14 will stop on the payline L.

Next, the main CPU 41 determines whether or not the combination of the symbols which has come to a stop on the payline L is a predetermined combination of “LOBSTER”s (step S16), and executes a stop control game described below (step S17) if the combination of “LOBSTER”s has come to a stop on the payline L. Here, the occasion that a predetermined combination stopped multiple times in succession may be used as a trigger to execute the stop control game. For example, it may be configured such that the stop control game is executed if the combination of “LOBSTER”s stopped on the payline L multiple times in succession.

On the other hand, if the combination of the symbol which has come to a stop on the payline L is not the combination of “LOBSTER”s, it is determined whether or not the bonus trigger has been established, i.e., the combination of “APPLE”s has come to a stop on the payline L. If it is determined that the bonus trigger has been established, the bonus game process described below is executed (step S19).

In addition, if the bonus trigger has not been established, it is determined whether or not a winning combination, for example, the combination of “PLUM”s has come to a stop (step S20). If it is determined that a winning combination has been achieved, payout is made according to the winning combination (step S21).

When saving the coins paid out, the main CPU 41 adds a predetermined number of credits to the number of credits stored in the RAM 43. In addition, when paying out coins, the main CPU 41 transmits a control signal to the hopper 66 and executes payout of a predetermined number of coins. In this circumstance, the coin detecting unit 67 counts the number of coins to be paid out from the hopper 66, and transmits a payout completion signal to the main CPU 41 when the counted value reaches a specified number. This causes the main CPU 41 to stop the operation of the hopper 66, and the coin payout process is completed.

If it is determined that a winning combination has not been achieved (NO in step S20), i.e., in a losing event, payout of coins is not executed. The base game is executed in this manner.

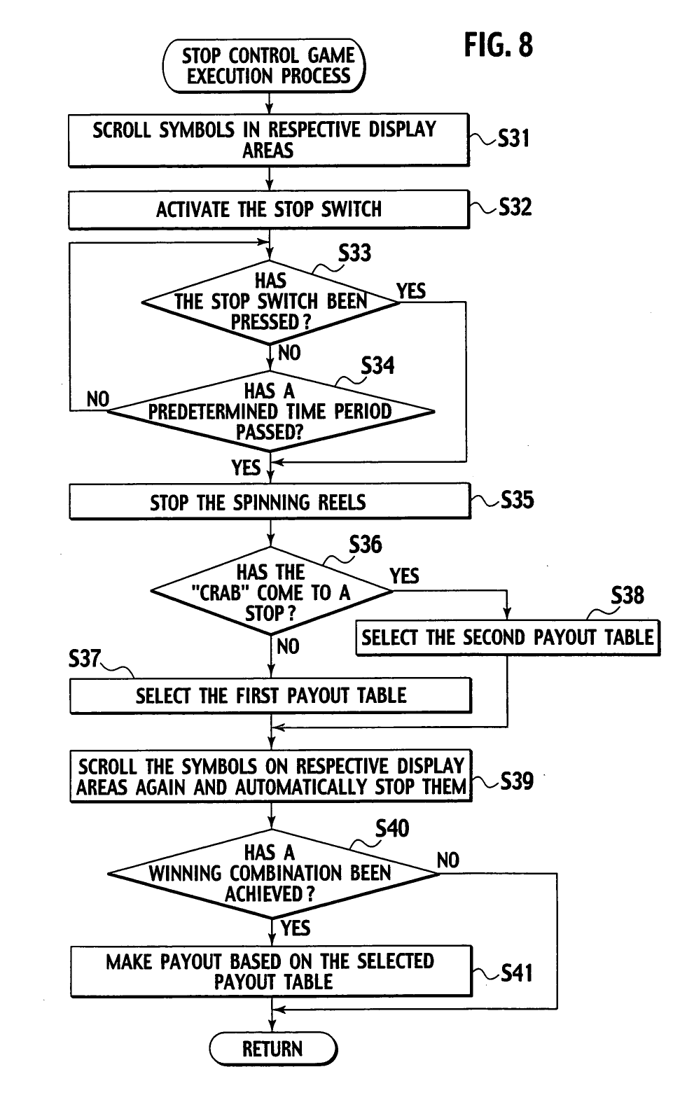

FIG. 8 is a flow chart illustrating a process sequence of the stop control game. When the stop control game is executed in the process of step S17 shown in FIG. 7, the main CPU 41 scrolls the symbols in each of the five columns of the display areas 28 (28a to 28e) (step S31). In the process of step S31, scrolling of the symbols may be started automatically when the stop control game is executed, that is when the symbol “LOBSTER”s have come to a stop in the process of step S16 of FIG. 7, or scrolling of the symbols may be started after the 1-bet button 26 or the maximum bet button 27 is newly pressed and the spin button 23 is pressed.

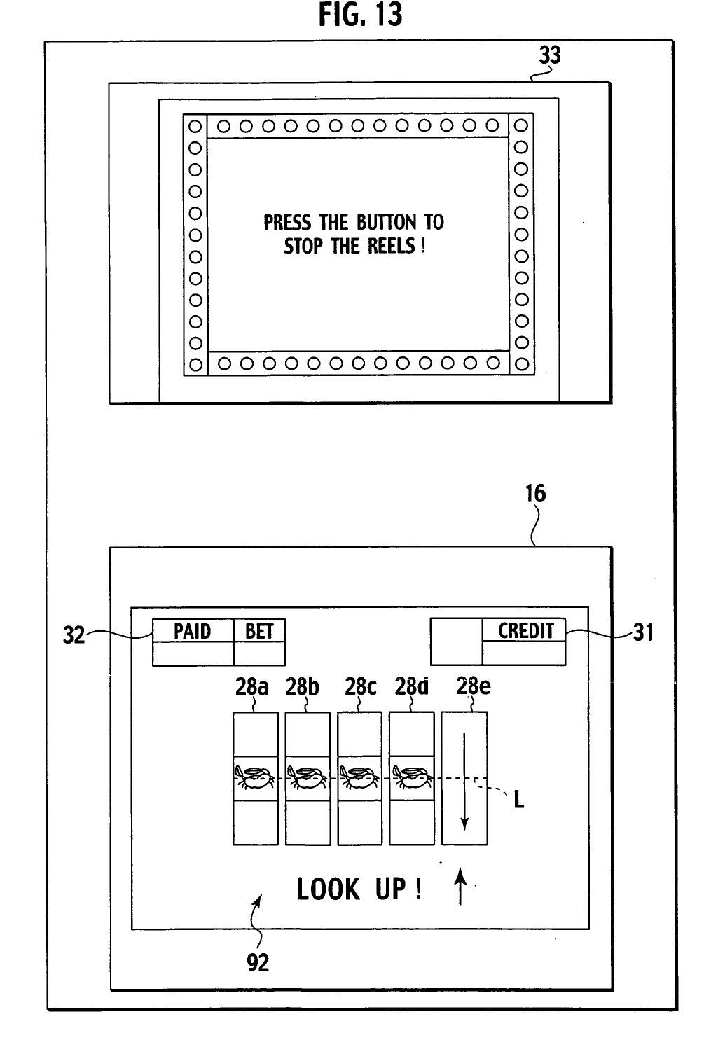

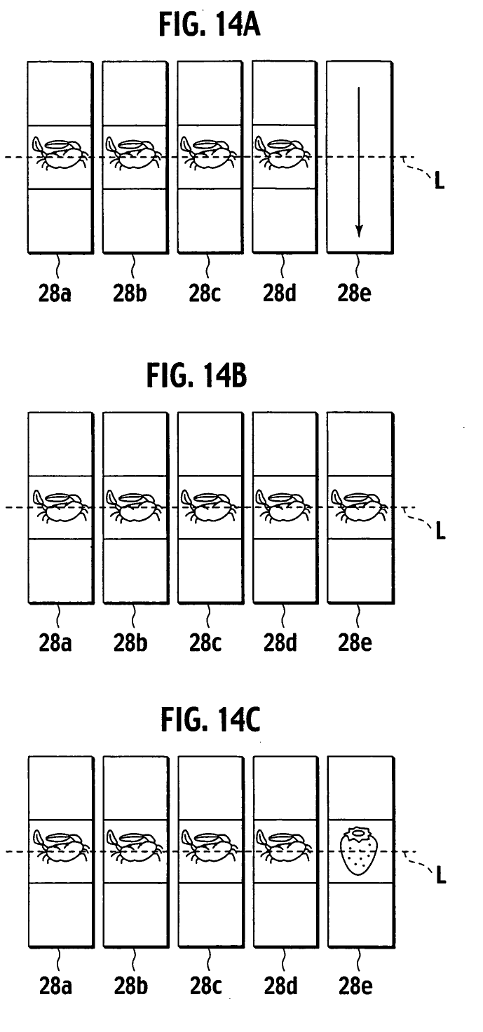

Then, the main CPU stops the symbol “CRAB”s on the payline L of the four columns (28a to 28d) of the five columns (28a to 28e) of the display areas 28, as shown in FIG. 14A, and keeps only the remaining display area 28e scrolling. Furthermore, the main CPU 41 activates the operation of the stop switch 82 (step S32). In other words, the symbols being scrolled on the display area 28e can be stopped by the player's operation of pressing the stop switch 82. Furthermore, the display lamp 83 provided to the stop switch 82 lights up. In addition, a character string “PRESS THE BUTTON TO STOP THE REELS” is displayed on the upper display panel 33 of the slot machine 10, as shown in FIG. 13. Furthermore, an arrow pointing upward and an image 92 showing “LOOK UP!” are displayed at the bottom of the lower display panel 16, whereby the player can be notified that the stop control game is being executed. Notification using audio or illuminations may be provided simultaneously.

Next, the main CPU 41 determines whether or not the stop switch 82 is pressed (step S33). If the stop switch 82 is pressed, the main CPU 41 stops the symbols being scrolled on the display area 28e at the timing when the stop switch 82 is pressed (step S35). In this case, the main CPU 41 accepts the detection signal of the detection sensor (not shown) provided in the stop switch 82 and stops the symbols being scrolled upon detecting that stop switch 82 is pressed.

In addition, if the stop switch 82 has not been pressed (NO in step S33) by the player for a period longer than a predetermined time, the symbols being scrolled on the display area 28e are automatically stopped (step S35) after a predetermined time period has passed (YES in step S34).

Subsequently, the main CPU 41 determines whether or not a combination of the specific symbol “CRAB”s has come to a stop on the payline L (step S36).

If the main CPU 41 determines that the symbol “CRAB”s have come to a stop on the payline L as shown in FIG. 14B (YES in step S36), the second payout table shown in FIG. 4B is selected as the payout table (step S38). On the other hand, the first payout table shown in FIG. 4A is selected (step S37) as the payout table if it is determined as shown in FIG. 14C that the symbol “CRAB”s have not come to a stop on the payline L (NO in step S36).

Then, the main CPU 41 scrolls the symbols displayed on each of the five columns of the display areas 28 (28a to 28e) again, and sequentially stops the symbols being scrolled on each of the display areas 28 (28a to 28e) (step S39). Subsequently, the main CPU 41 determines whether or not the symbols composing a winning combination have come to a stop on the payline L (step S40). If it is determined that symbols composing a winning combination have come to a stop (YES in step S40), payout is made referring to the payout table selected in the process of steps S37 and S38 (step S41).

As shown in FIGS. 4A and 4B described above, the second payout table is prepared to payout a larger amount than the first payout table when a winning combination is achieved on the payline L. For example, if the symbol “CHERRY”s are aligned as the winning combination, 20 coins are paid out when the first payout table is selected whereas 30 coins are paid out when the second payout table is selected.

Therefore, if the player presses the stop switch 82 and succeeds in stopping the symbols being scrolled to align them into a combination of specific symbols (“CRAB” in this example) while the stop control game is being executed, the player can obtain a larger amount of payout in the following game when a winning combination is achieved on the payline L of the display areas 28.

Additionally, in the present embodiment, an example has been described wherein two payout tables, namely, a first payout table and a second payout table are prepared such that the second payout table defining a larger amount of payout is selected when the player succeeded in stopping specific symbols (e.g., “CRAB”) in the stop control game. However, the present invention, not limited to the above example, may be arranged such that three or more payout tables defining different numbers of coins to be paid out are prepared and the stop control game is executed two or more times, whereby allowing selection of a payout table which payouts a larger number of coins when a larger number of times specific symbols have been stopped during the multiple execution of the stop control game.

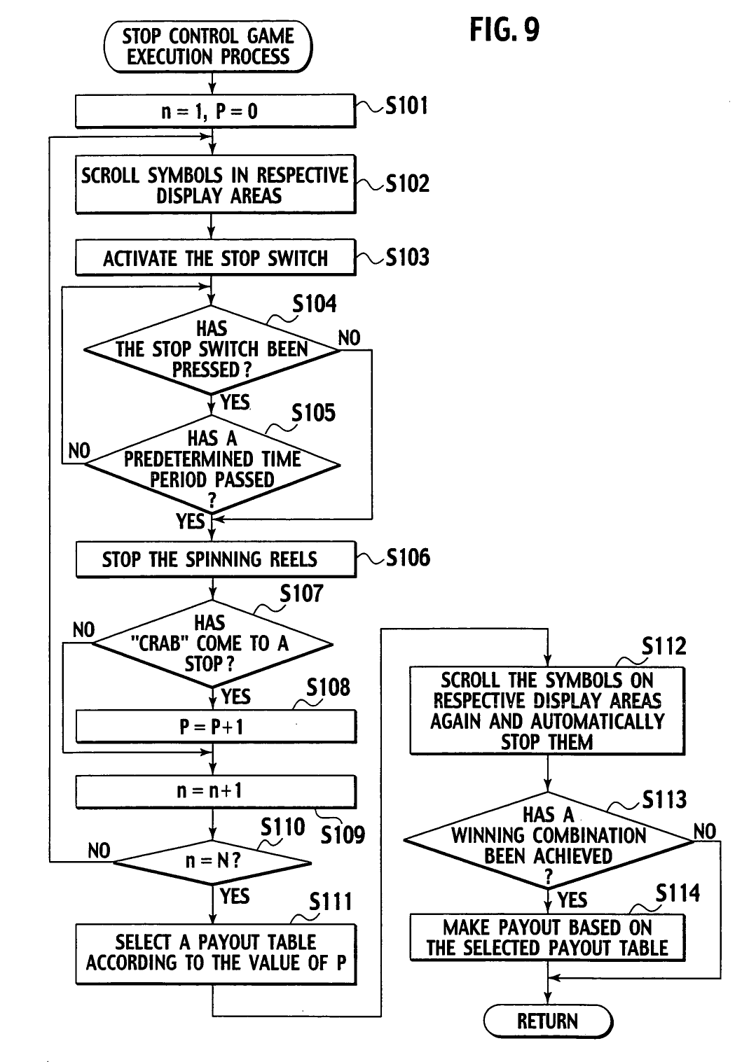

In the following, a modification of the stop control game based on the above will be explained referring to the flow chart shown in FIG. 9. When the stop control game is executed in the process of step S17 shown in FIG. 7, the main CPU 41 sets the value n indicating the number of times the stop control game is executed as n=1, and sets the value P indicating the number of times specific symbols in the stop control game have been stopped as P=0 (step S101).

Then the main CPU 41 scrolls the symbols in each of the five columns of the display areas 28 (28a to 28e) (step S102). In the process of step S102, scrolling of the symbols may be started automatically when the stop control game is executed, or scrolling of the symbol may be started after the 1-bet button 26 or the maximum bet button 27 is newly pressed and the spin button 23 is pressed.

The main CPU then stops the symbol “CRAB”s on the payline L of the four columns (28a to 28d) of the five columns of the display areas 28 (28a to 28e), as shown in FIG. 14A, and keeps only the remaining display area 28e scrolling. Furthermore, the main CPU 41 activates the operation of the stop switch 82 (step S103). In other words, the symbols being scrolled on the display area 28e can be stopped by the player's operation of pressing the stop switch 82. Furthermore, the display lamp 83 provided to the stop switch 82 lights up. In addition, a character string “press the button to stop the reels” is displayed on the upper display panel 33 of the slot machine 10, as shown in FIG. 13. Furthermore, an arrow pointing upward and an image 92 showing “LOOK UP!” are displayed at the bottom of the lower display panel 16, whereby the player can be notified that the stop control game is being executed. Notification using audio or illuminations may be provided simultaneously.

Next, the main CPU 41 determines whether or not the stop switch 82 is pressed (step S104). If the stop switch 82 is pressed, the main CPU 41 stops the symbols being scrolled on each of the display area 28e at the timing when the stop switch 82 is pressed (step S106). In this case, the main CPU 41 accepts the detection signal of the detection sensor (not shown) provided in the stop switch 82 and stops the symbols being scrolled upon detecting that stop switch 82 is pressed.

In addition, if the stop switch 82 has not been pressed (NO in step S104) by the player for a period longer than a predetermined time, the symbols being scrolled on the display area 28e are automatically stopped (step S106) after a predetermined time has passed (YES in step S105).

Subsequently, the main CPU 41 determines whether or not a combination of the symbol “CRAB”s, which is a specific symbol, has come to a stop on the payline L (step S107). If the main CPU 41 has determined that the symbol “CRAB”s have come to a stop on the payline L as shown in FIG. 14B (YES in step S107), the value P indicating the number of times the stop control game succeeded is set as P=1 (step S108).

Next, the value n indicating the number of times the stop control game is executed is set as n=1 (step S109). Subsequently, it is determined (step S110) whether or not the number of execution times n of the stop control game has reached a preset number of times N (N is 5, for example). If the value of n has not reached N (NO in step S110), the process is repeated from step S102.

On the other hand, if n=N is satisfied (YES in step S110), a payout table is selected depending on the value of P at the time (step S11). In this modification, six types of payout table (not shown) are prepared with different amount of payout at the time a winning combination is achieved, where the payout table with the largest amount of payout is selected when a combination of “CRAB”s, which is the specific symbol, has come to a stop with P=5, i.e., in all of five-time executions of the stop control game. Or, in the case of P=4, a payout table with the second largest amount of payout is selected. Similarly, payout tables with smaller amount of payout are selected as the value of P becomes smaller.

The main CPU 41 then executes a process to scroll the symbols on the display areas 28 (28a to 28e) again and subsequently stop them (step S112). Accordingly, if symbols composing a winning combination have come to a stop on the payline L (YES in step S113), payout is made using the payout table selected in step S111 (step S114). Thus, the player can obtain a larger amount of payout by playing the stop control game multiple times (e.g., five times) and succeeding in stopping the symbol at a specific combination.

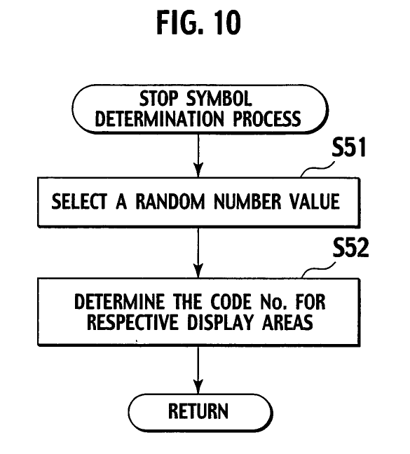

Next, a process for determining the symbols to be stopped which is shown in step S14 of FIG. 7 will be described, referring to the flow chart shown in FIG. 10.

FIG. 10 is a flow chart illustrating the procedure of a process of determining the symbols to be stopped, which is shown in step S14 of FIG. 7. The process is executed by the main CPU 41 executing the stop symbol determination program stored in the RAM 43.

First, the main CPU 41 selects random number values corresponding to each of the columns of the display areas 28 (28a to 28e) from a numeral range of 0 to 255 by executing a random number generation program included in the stop symbol determination program (step S51).

Next, the main CPU 41 refers to symbol weighting data according to the payout rate setting data which is output from the GAL 54 and stored in the RAM 43 and determines (step S52), based on five random number values selected, code numbers (see FIG. 3) for each of the display areas 28 (28a to 28e).

The code numbers for each of the display areas 28 (28a to 28e) correspond to the code numbers of the symbols to be displayed in a stopped state on the payline L. The main CPU 41 determines a winning combination by determining the code number for each of the display areas 28. For example, if the code numbers for each of the display areas 28 (28a to 28e) are determined as “00”, “00”, “00”, “00”, “00” respectively, the main CPU 41 have determined the winning combination as “JACKPOT 7”.

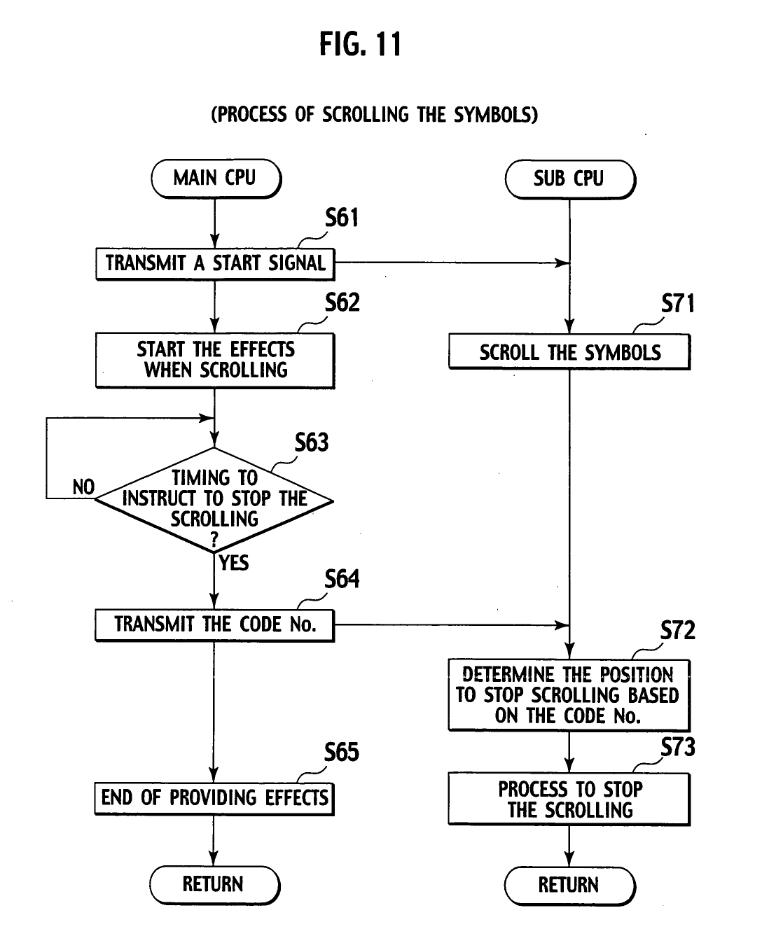

FIG. 11 is a flow chart illustrating the process of scrolling the symbols shown in step S15 of FIG. 7 in. Here, the process is executed between the main CPU 41 and the sub CPU 61.

First, the main CPU 41 transmits, to the sub CPU 61, a start signal to start scroll of symbols on the display areas 28 of the liquid crystal display unit 17 (step S61). Upon accepting the start signal from the main CPU 41, the sub CPU 61 outputs, to the VDP 46, a scroll command of the symbols. The VDP 46 reads image data of the symbols stored in the image data ROM 47, and scrolls the symbols on the five columns of the display areas 28 (28a to 28e) of the liquid crystal display unit 17 (step S71), whereby scrolling of the symbols is started in each of the five columns of the display areas 28 (28a to 28e).

After having transmitted the start signal to the sub CPU 61 in step S61 shown in FIG. 11, the main CPU 41 provides effects while the symbols are being scrolled (step S62). The process displays images to the lower display panel 16 or outputs sound from the loudspeaker 29 for a period (e.g., three seconds) defined by the result of determining the symbols to be stopped (step S14 of FIG. 7).

Next, the main CPU 41 determines whether or not it is a proper timing to instruct to stop the scrolling has come (step S63 of FIG. 11).

If, in the process of step S63, it is determined that it is not a proper timing to instruct to stop the scrolling, the process returns to step S63 and continues to provide effects during the scrolling. Otherwise, if, in the process of step S63, it is determined that it is a proper timing to instruct to stop the scrolling, the Main CPU 41 transmits the code number of the symbol stored in the RAM 43 to the sub CPU 61 (step S64). Upon accepting the code number of the symbol from the main CPU 41, the sub CPU 61 determines the position to stop the scrolling in accordance with the code number (step S72).

Subsequently, a process to stop the scrolling is executed, whereby the symbols are displayed in a stopped state (step S73) on each of the display areas 28 (28a to 28e) inside each of the display windows 15 (15a to 15e). In addition, the process of displaying effect images by the main CPU 41 is completed (step S65).

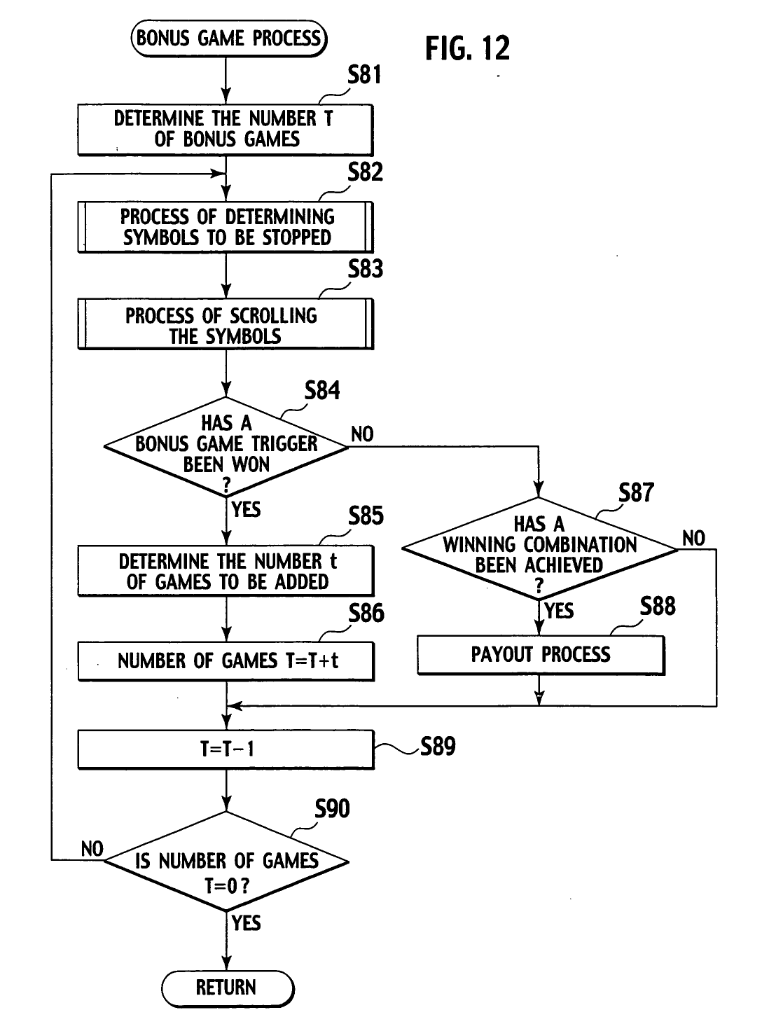

FIG. 12 is a flow chart illustrating the bonus game process shown in step S19 of FIG. 7. In the bonus game process, the main CPU 41 first determines, based on the random number value obtained by executing a random number generation program included in the stop symbol determination program stored in the RAM 43, the number of execution times T of the bonus game from 10 to 25 games (step S81). The main CPU 41 stores, in RAM 43, data of the determined number of games T of the bonus game.

Next, the main CPU 41 executes a process of determining the symbols to be stopped (step S82) and a process of scrolling the symbols (step S83). The process of step S82 is generally similar to the process explained using FIG. 10. Likewise, the process of step S83 is generally similar to the process explained using FIG. 11. Since these processes have already been described, duplicate description will be omitted here.

Next, in FIG. 12, main CPU 41 determines whether or not the bonus trigger has been established, i.e., the combination of “APPLE”s has come to a stop on the payline L formed on the display areas 28 (28a to 28e) inside the display windows 15 (step S84). If it is determined that the bonus game trigger has been established (YES in step S84), the number of repetition t of the bonus game is newly determined (step S85). The determined number of repetition t is added to the game number T of the current bonus game (step S86), whereby the remaining number of times of the bonus game increases if the bonus game is won again during execution of the bonus game.

If the bonus game trigger has not been established, the main CPU 41 determines whether or not a winning combination is achieved (step S87). If it is determined that a winning combination has been achieved (YES in step S87), the main CPU 41 executes payout of coins according to the number of coins inserted and the winning combination (step S88). In this event, payout is made based on the first payout table shown in FIG. 4A.

When the process of step S86 or S88 is executed, or if it is determined in step S87 that none of the winning combination is achieved (determined to be losing), the main CPU 61 reads out the game number T of the bonus game stored in the RAM 43 and subtracts a value 1 from the read-out game number T. Then, the game number T after subtraction is stored in the RAM 43 again (step S89).

Subsequently, the main CPU 41 determines whether or not the game number T of the bonus game has reached the number of times determined in step S81 (step S90). Specifically, the determination is based on whether or not the game number T stored in the RAM 43 has become zero. If the game number T is not zero, in other words, if it is determined that the number of execution times of the bonus game has not reached the number of times determined in step S81, the process returns to step S82 and the above process is repeated.

On the other hand, if the game number T is zero, in other words, if it is determined that the number of execution times of the bonus game has reached the number of times determined in step S81, the process is completed. The bonus game is executed in this manner.

FIG. 13 is an illustration of an exemplary image displayed on the upper display panel 33 and the lower display panel 16 when the stop control game is executed. An arrow pointing upward and an image 92 of characters “LOOK UP!” are displayed at the bottom of the lower display panel 16. The image 92 is for prompting the player to look at the upper display panel 33.

A character string “PRESS THE BUTTON TO STOP THE REEL” is displayed on the upper display panel 33. Looking at the display, the player can recognize that the symbols being scrolled can be stopped by pressing the stop switch 82.

In this manner, with the slot machine and playing method according to the present embodiment, a stop control game is started when a combination of predetermined symbols such as the “LOBSTER”, for example, has come to a stop on the payline L, wherein the symbols being scrolled on the display areas 28 can be stopped by the player's operation of pressing the stop switch 82. Then, the player presses the stop switch 82 to stop the symbols being scrolled, whereby a payout table is selected which provides a larger amount of payout when a combination of specific symbols such as that of the “CRAB”, for example, has come to a stop on the payline L than when the combination of the specific symbols does not come to a stop, determining the amount of payout in the following game when a winning symbol has come to a stop.

Therefore, since a larger amount of payout can be obtained when a combination of specific symbols comes to a stop in the stop control game than when the combination of specific symbols does not come to a stop while the stop control game is being executed, the player will be attracted by the stop control game without losing concern or interest to the game.

Additionally, in the case the stop control game is executed for multiple times, since a payout table defining a larger amount of payout is selected for a larger number of times a combination of specific symbols has successfully been stopped in the multiple executions of the stop control game, the player is encouraged to be highly interested in the stop control game.

Furthermore, since the player can obtain a larger amount of payout if the player succeeds in stopping a combination of specific symbols more times while the stop control game is being executed, the game can have room for using technique.

Although embodiments of a slot machine according to the present invention have been described as above, they are for illustrative purpose only and not intended to limit the present invention in particular, the specific arrangements of respective units may be suitably changed in design. In addition, since the advantages described in the embodiments of the present invention only enumerate the most preferred advantages which rise from the present invention, advantages of the present invention are not limited to those described in the embodiments of the present invention.

What is claimed is:

1. A slot machine accompanied with a case in which a plurality of symbols that have been arranged on a display are automatically rearranged and a case in which the plurality of symbols are rearranged by accepting a control input signal from an external,
the slot machine comprising a controller operable to execute a control such that an amount of payout for subsequent winning combinations is varied depending on whether or not a specific combination of the symbols has been rearranged when the symbols are rearranged by accepting the control input signal.

2. The slot machine according to claim 1,
wherein the controller is operable to execute a control such that the amount of payout for subsequent winning combinations is made larger in the case that the specific combination of symbols has been rearranged than in the case of not being rearranged when the symbols are rearranged by accepting the control input signal from an external.

3. The slot machine according to claim 1,
wherein the controller is operable to execute a control such that,
when automatic rearrangement of the plurality of symbols resulted in a predetermined combination of symbols on the display,
(i) the symbols are set to be capable of rearrangement by accepting a control input signal from an external only for the following unit game and
(ii) the amount of payout for subsequent winning combinations is varied, depending on whether or not the specific combination of symbols has been rearranged by accepting the control input signal.

4. The slot machine according to claim 1,
wherein the controller is operable to execute a control such that,
when automatic rearrangement of the plurality of symbols resulted in a predetermined combination of symbols on the display,
(i) the symbols are set to be capable of rearrangement by accepting a control input signal from an external in multiple times of unit game thereafter and
(ii) the amount of payout for subsequent winning combinations is varied depending on the number of times the specific combination of symbols has been rearranged in the multiple times of the unit game.

5. A slot machine accompanied with, when rearranging a plurality of symbols arranged on a display, a case in which the plurality of symbols are automatically rearranged and a case in which the plurality of symbols are rearranged by accepting a control input signal from an external,
the slot machine comprising a controller operable to:
(a) execute a unit game rearranging the symbols by accepting the control input signal from an external when automatic rearrangement of the plurality of symbols resulted in a predetermined combination of symbols, and
(b) execute a control such that the amount of payout for subsequent winning combinations is varied, depending on whether or not a specific combination of symbols has been rearranged in the unit game.

6. The slot machine according to claim 5,
wherein the controller is operable to execute a control such that the amount of payout for subsequent winning combinations is made larger in the case that the specific combination of symbols has been rearranged than in the case of not being rearranged when the symbols are rearranged by accepting the control input signal from an external.

7. The slot machine according to claim 5,
wherein the controller is operable to execute a control such that,
when automatic rearrangement of the plurality of symbols resulted in the predetermined combination of symbols on the display,
(i) the symbols are set to be capable of rearrangement by accepting a control input signal from an external only for the following unit game and
(ii) the amount of payout for subsequent winning combinations is made larger in the case that the specific combination of symbols has been rearranged by accepting the control input signal than in the case of not being rearranged.

8. The slot machine according to claim 5,
wherein the controller is operable to execute a control such that,
when automatic rearrangement of the plurality of symbols resulted in the predetermined combination of symbols on the display,
(i) the symbols are set to be capable of rearrangement by accepting a control input signal from an external in multiple times of unit game thereafter and
(ii) the amount of payout for subsequent winning combinations is increased for a larger number of times the specific combination of symbols has been rearranged in the multiple times of the unit game.

9. A slot machine comprising:
a display for arranging a symbol matrix formed by a plurality of columns and a plurality of rows;
an arrangement controller for selecting and determining symbols to be arranged into the symbol matrix from a plurality of types of symbols in order to rearrange a plurality of symbols which have been arranged on the display as a new symbol matrix after scrolling the plurality of symbols, and executing an arrangement control to stop the scrolling state at the arrangement of the determined symbols;
a stop switch operable by a player and connected to the arrangement controller;
a plurality of payout tables for setting different payouts respectively for the same winning combination;
a stop switch controller for executing a stop control game which sets the symbols to be capable of rearrangement regardless of the arrangement control of the arrangement controller, in accordance with the input timing by the player of the stop switch in the following unit game, when a predetermined combination of symbols has been rearranged along a payline set for the symbol matrix; and
a table selection controller for selecting different payout tables to determine the amount of payout depending on whether or not a specific combination of symbols has been rearranged by execution of the stop control game, when a winning combination is rearranged in a subsequently executed unit game.

10. The slot machine according to claim 9,
wherein the payout table selection controller selects a payout table which provides a larger amount of payout when the specific combination of symbols has been rearranged by execution of the stop control game than when the specific combination of symbols has not been rearranged.

11. The slot machine according to claim 9,
wherein the stop switch controller notifies the player that the stop control game is executed.

12. A playing method of a slot machine, comprising:
repeating execution of a unit game in which a plurality of symbols are rearranged into a combination of symbols determined by the controller, from a state in which the plurality of symbols are arranged on the display, and
in each of the unit games accompanied with a case in which a plurality of symbols that have been arranged on the display are automatically rearranged and a case in which the plurality of symbols are rearranged by accepting a control input signal from an external, executing a control to vary the amount of payout for subsequent winning combinations depending on whether or not a specific combination of symbols has been rearranged at the rearrangement by accepting the control input signal.

13. The playing method of a slot machine according to claim 12, further comprising:
executing a control such that, when the symbols are rearranged by accepting the control input signal from an external, the amount of payout for subsequent winning combinations is made larger in the case that the specific combination of symbols has been rearranged than in the case of not being rearranged.

14. The playing method of a slot machine according to claim 12, further comprising:
when automatic rearrangement of the plurality of symbols resulted in a predetermined combination of symbols on the display,
setting the symbols to be capable of rearrangement by accepting a control input signal from an external only for the following unit game, and
executing a control such that the amount of payout for subsequent winning combinations is varied, depending on whether or not the specific combination of symbols has been rearranged by accepting the control input signal.

15. The playing method of a slot machine according to claim 12, further comprising:
when automatic rearrangement of the plurality of symbols resulted in a predetermined combination of symbols on the display,
setting the symbols to be capable of rearrangement by accepting a control input signal from an external in multiple times of the unit game thereafter, and
executing a control such that the amount of payout for subsequent winning combinations is varied, depending on the number of times the specific combination of symbols has been rearranged in the multiple times of the unit game.

16. A playing method executed by a slot machine, comprising:
determining a plurality of symbols for rearrangement prior to their rearrangement by a controller to rearrange a combination of symbols on the display when a plurality of symbols have been arranged on a display to be later rearranged thereon;
activating a stop switch connected to the controller to set the plurality of symbols to be capable of rearrangement by input from the stop switch regardless of the control of the controller when the plurality of rearranged symbols compose a predetermined combination; and
varying the amount of payout to a player depending on whether or not a specific combination of symbols has been rearranged by the input from the stop switch.

17. The playing method executed by a slot machine according to claim 16,
wherein the amount of payout to the player is made larger when the specific combination of symbols has been rearranged by the input from the stop switch than when the specific combination of symbols has not been rearranged.

18. A playing method executed by a slot machine, repeating a unit game in which a game starts by scrolling a plurality of symbols on a display according to the control of a controller, and the game ends by stopping at a combination of symbols determined by the controller, the playing method comprising:
a first step in which, when a predetermined combination of symbols has been rearranged on the display, the symbols scrolled on the display are put under a controlled state so that they can be rearranged based on an input signal from a stop switch connected to the controller;
a second step in which, under the controlled state, it is determined whether or not the combination of symbols rearranged based on the input signal turns out to be a specific combination;
a third step in which it is determined whether or not a winning combination has been rearranged in a unit game after the controlled state; and
a fourth step in which, when it is determined that the winning combination has been rearranged in the third step, the amount of payout to the player is made larger when it is affirmed that the determination result in the second step indicates the specific combination, than when it is negated.
